(19) United States
(12) Patent Application Publication
(10) Pub. No.: US 2025/0157440 A1
(43) Pub. Date: May 15, 2025

(54) OVIEDO UNIVERSAL SLIDES PULLER

(71) Applicant: Carlos Oviedo, Greenacres, FL (US)

(72) Inventor: Carlos Oviedo, Greenacres, FL (US)

(21) Appl. No.: 18/509,695

(22) Filed: Nov. 15, 2023

(51) Int. Cl. G10D 9/00; G10D 7/10

(52) U.S. Cl. CPC G10D 9/00; G10D 7/10

(57) ABSTRACT

The Oviedo Universal Slides Puller (OUSP) is a comprehensive toolset designed for brass-wind musical instrument repairers. The OUSP allows technicians to safely extract stuck tuning slides without causing any damage to the instrument's finish. By employing a unique force distribution technique, the OUSP efficiently removes stuck slides, eliminating the need for laborious disassemblies and reassemblies. The tool's cost-effectiveness, user-friendly design, and compatibility with traditional methods make it a valuable asset to professionals and skilled musicians in the industry.

### BACKGROUND OF THE INVENTION

The Oviedo Universal Slides Puller (OUSP) is an innovative tool designed to facilitate the extraction of stuck tuning slides in brass-wind musical instruments. Traditional methods of dealing with such issues often involve time-consuming disassemblies and reassemblies, leading to marks, scratches, and damage to the instrument. The OUSP aims to address these challenges by providing a 100% effective, non-destructive, and efficient solution to safely remove stuck slides.

The invention pertains to the field of musical instrument repair tools, specifically those used for brass-wind instruments to handle the extraction of stuck tuning slides.

### SUMMARY OF THE INVENTION

The Oviedo Universal Slides Puller (OUSP) is a comprehensive toolset that allows a single technician to extract stuck slides from brass-wind instruments independently. The toolset includes two steel handles, five squared steel casings of different dimensions, seven adjustable sliding steel rods, and several pivoting and fixing screws. The OUSP employs a unique force distribution technique to pull the stuck slide out while preventing any damage to the instrument. It effectively eliminates the need for laborious disassemblies and reassemblies and offers a simple yet efficient approach to slide extraction.

### BRIEF DESCRIPTION OF DRAWINGS

FIG. 1 depicts a perspective side view of the Oviedo Universal Slides Puller.

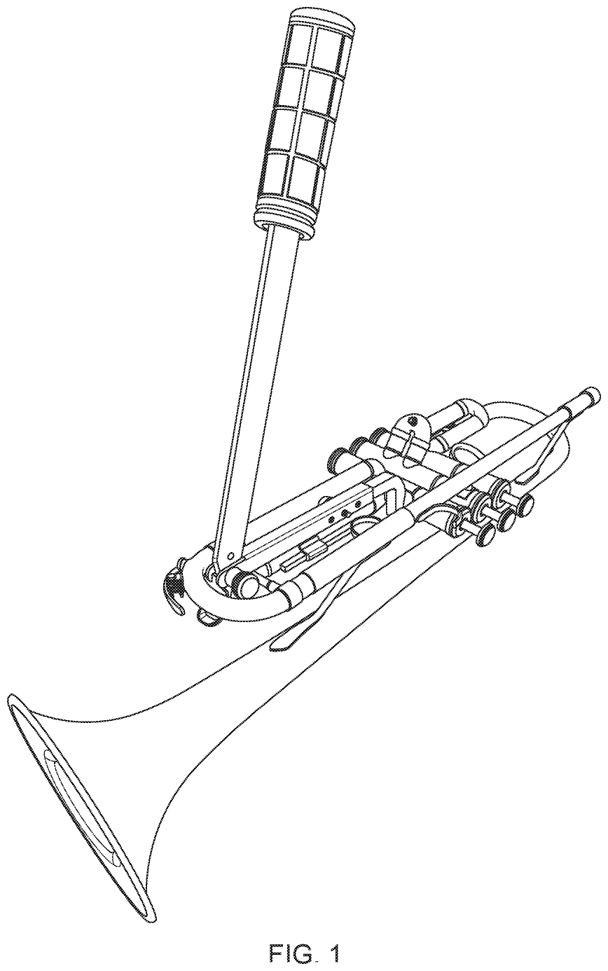

### DETAILED DESCRIPTION OF THE INVENTION

The Oviedo Universal Slides Puller (OUSP) is specifically designed to resolve the challenges faced by brass-wind musical instrument repairers when dealing with stuck tuning slides. It is crucial for these technicians to remove the slides smoothly without causing any harm to the instrument's delicate finish.

The OUSP consists of two steel handles shaped based on the dimensions of the slide crook, five squared steel casings of varying sizes, seven adjustable sliding steel rods, and several pivoting and fixing screws. The design allows for easy assembly and interchangeability of casings and rods, providing versatility for different instruments and slide configurations.

To use the OUSP, the technician selects the appropriate handle, casing, and rod according to the slide crook's shape and distance to the opposite contact point. The tool is then assembled by attaching the casing to the handle and fixing it in place with screws.

The OUSP's unique force distribution mechanism ensures that a linear force is applied to both slide tubes, facilitating the smooth extraction of the stuck slide. This force distribution technique significantly reduces the risk of damaging the instrument and eliminates the need for complex disassemblies.

The pivoting hole, positioned 35 mm from the lower point of the OUSP, allows technicians to attach the selected casing and secure it with a screw. The OUSP also comes with optional crook dent buffers (CDB) made of epoxy putty, which provide additional protection for specific situations where the slide's delicate components require extra care during the extraction process.

During testing at Music Man Inc. Repair Shop by Carlos Oviedo, a Brass Repair Specialist, the OUSP has been successfully tested on over 200 instruments, demonstrating its 100% effectiveness in slide extraction.

One of the OUSP's main advantages is its cost-effectiveness. Manufactured from durable steel, the tool offers longevity and reliability, ensuring that it remains a valuable asset to instrument repair professionals for years to come.

Additionally, the OUSP's user-friendly design and straightforward operation make it accessible to a wide range of users, including professional repair technicians and skilled musicians.

The OUSP offers a novel concept of focused linear force application to stuck slides, enabling technicians to work with one hand free to tap on receivers while exerting pressure. This innovative approach, combined with the tool's compatibility with traditional methods, eliminates the need to unsolder the crook, significantly improving efficiency and reducing repair time.

The Oviedo Universal Slides Puller (OUSP) represents a significant step forward in the field of musical instrument repair, providing a safe, effective, and non-destructive solution to the challenges of extracting stuck slides.

1. A toolset for extracting stuck tuning slides from brass-wind musical instruments, comprising:
Two steel handles,
Five squared steel casings of varying sizes,
Seven adjustable sliding steel rods,
Pivoting and fixing screws.

2. The toolset of claim 1, wherein the steel handles are shaped based on the dimensions of the slide crook, facilitating ease of use for technicians.

3. The toolset of claim 1, wherein the squared steel casings are interchangeable and can be selected based on the shape and dimensions of the stuck tuning slide.

4. The toolset of claim 1, further comprising a pivoting hole positioned 35 mm from the lower point of the toolset, enabling the attachment of selected casings for securing them in place.

5. The toolset of claim 1, wherein crook dent buffers (CDB) made of epoxy putty are provided for additional protection of delicate components during the extraction process.

6. A method for using the toolset of claim 1, comprising the steps of:
a. Selecting an appropriate steel handle, casing, and rod based on the shape and dimensions of the stuck tuning slide,
b. Assembling the selected casing to the handle and securing it in place with screws,
c. Attaching the toolset to the stuck tuning slide,
d. Applying linear force to both slide tubes using the toolset to facilitate the smooth extraction of the stuck tuning slide.

7. The method of claim 6, wherein the toolset allows technicians to work with one hand free to tap on receivers while exerting pressure, improving efficiency and reducing repair time.

8. The method of claim 6, wherein the toolset is 100% effective in extracting stuck tuning slides, without causing damage to the instrument's finish.

9. The method of claim 6, wherein the toolset is cost-effective and provides longevity and reliability due to its durable steel construction.

10. The method of claim 6, wherein the toolset is user-friendly and accessible to a wide range of users, including professional repair technicians and skilled musicians.
